(19) United States
(12) Patent Application Publication
(10) Pub. No.: US 2020/0084699 A1
(43) Pub. Date: Mar. 12, 2020

(54) BASE STATION AND USER EQUIPMENT

(71) Applicant: NTT DOCOMO, INC., Tokyo (JP)

(72) Inventors: Hideaki Takahashi, Tokyo (JP); Tooru Uchino, Tokyo (JP); Wuri Andarmawanti Hapsari, Tokyo (JP)

(73) Assignee: NTT DOCOMO, INC., Tokyo (JP)

(21) Appl. No.: 16/468,877

(22) PCT Filed: Nov. 20, 2017
(86) PCT No.: PCT/JP2017/041599

§ 371 Date: Jun. 12, 2019

(30) Foreign Application Priority Data
Jan. 6, 2017 (JP) 2017-001305

(51) Int. Cl. H04W 48/10; H04J 11/00

(52) U.S. Cl. CPC H04W 48/10; H04J 11/0069

(57) ABSTRACT

A disclosed base station includes a common broadcast information transmitter configured to transmit common broadcast information transmitted in common to a plurality of types of user equipment; and type-specific broadcast information transmitter configured to transmit type-specific broadcast information for each type of the user equipment, in accordance with scheduling information in the common broadcast information.

### TECHNICAL FIELD

The present disclosure relates to a radio communication system.

### BACKGROUND ART

In LTE (Long Term Evolution), the specifications up to Rel-12 support UEs (User Equipment: UE) accommodating all applicable bandwidths (1.4 MHz, 3 MHz, 5 MHz, 10 MHz, 15 MHz, and 20 MHz). UEs are thus enabled to receive broadcast information including a primary synchronization signal (PSS), a secondary synchronization signal (SSS), a cell specific reference signal (CRS), a master information block (MIB) and a system information block x (SIBx, where x is a number indicating a type of system information block), and tile like, to connect to a network without having limitations to the bandwidth to which network-based operations are allocated.

Rel-13 specifications support user equipment (eMTC) for a category M1 (Cat. M1) that corresponds only to the bandwidth of 1.4 MHz. Hence, for the user equipment for a category M1 defined in Rel-13, PSS, SSS, CRS, and MIB transmitted using 6 RBs in the center of the bandwidth are used as with Rel-12; however, for system information blocks such as SIB1 and SIB2 that may be transmitted using the 6 RBs or outside, transmission of SIBz dedicated to the user equipment for a category M1 is defined.

Furthermore, Rel-13 specifications support user equipment (UE) for NB-IoT (Narrow Broadband-Internet of Things) corresponding only to a bandwidth of 1 RB (180 KHz). Thus, all the broadcast information including PSS, SSS, CRS and MIB will be to be newly defined for UE NB-IoT.

The master information block (PBCH) is repeatedly transmitted every 10 ms with a periodicity of 40 ms for the legacy LTE UE categories up to Rel-12 and UE category M1. Specifically, for UE category M1, MIB can be transmitted twice every 10 ms. In contrast to the LTE UE categories up to Rel-12 and UE category M1, MIB can be repeatedly transmitted every 10 ms with a periodicity of 640 ms for UE NB-IoT.

A system information block 1 (SIB1) is transmitted with a periodicity of 80 ms for LTE UE categories up to Rel-12, and is transmitted in a subframe #5 of a radio frame that satisfies SEN mod8=0. Further, SIB1 can be repeatedly transmitted every 20 ms with a periodicity of 80 ms; that is, SIB1 is transmitted in a subframe #5 of a radio frame that satisfies SFN mod2=0. For LTE UE categories up to Rel-12, the location on the frequency axis and the number of RBs for transmission of SIB1 are indicated in PDCCH (Physical Downlink Control Channel), which also includes the SIB1 for repeated transmission.

For UE category M1, SIB1 is transmitted with a periodicity of 80 ms similarly to the LTE UE categories up to Rel-12. However, for UE category M1, a transport block size (TBS) and the number of repetitions are specified (semi-statically) in MIB, without use of PDCCH. Further, the location on the frequency axis on which SIB1 is transmitted is determined according to PCID (Physical Cell ID) using frequency hopping.

In addition, for UE NB-IoT, SIB1 is transmitted with a periodicity of 2560 ms. Further, similarly to UE category M1, a TBS and the number of repetitions are specified in MIB, without use of PDCCH. Note that, as described above, since MIB differs between the category MI and NB-IoT, SIB1 is independently transmitted to each of the UE category M1 and UE NB-IoT. Specifically, SIB1 for UE NB-IoT is transmitted in a subframe #4 of every other radio frame within 16 consecutive radio frames.

Regarding System Information Block X (SIBx) as from System Information Block 2 (SIB2) onward, the periodicity of SIBx and a window length according to which the SIBx is transmitted are indicated in SIB1, and resources on the frequency axis on which SIBx is transmitted are indicated in the PDCCH, for LTE UE categories up to Rel-12. For UE category M1, the periodicity of SIBx and a window length according to which the SIBx is transmitted are indicated in SIB1, as with the LTE UE categories up to Rel-12. However, resources on the frequency axis on which SIBx is transmitted are semi-statically set together with the periodicity in SIB1, not in PDCCH. Further, for UE NB-IoT, only 1 RB is used in the frequency direction; resources of SIBx are thus constantly fixed.

### RELATED ART DOCUMENTS

### Non-patent Documents

### [NON-PATENT DOCUMENT 1] 3GPP TR 38.804 V0.4.0 (2016-11)

### [NON-PATENT DOCUMENT 2] 3GPP R2-168288

### SUMMARY OF THE INVENTION

### Problem to be Solved by the Invention

As described above, at present, a mechanism for transmitting broadcast information is different for each of UEs for legacy LTE categories (in particular, for LTE UE categories up to Rel-12), category M1, and NB-IoT. This will increase radio resources used for transmitting broadcast information, which is not desirable from the viewpoint of system utilization efficiency. Accordingly, it is desirable to provide a broadcast information transmission system for 5G or NR (New RAT) that can manage the above-described considerations of system utilization efficiency.

In light of the above-considerations, it is an object of the present invention to provide a technique for efficiently transmitting broadcast information to various types of user equipment.

### Means for Solving the Problem

According to an aspect of embodiments, a base station includes

a common broadcast information transmitter 110 configured to transmit common broadcast information transmitted in common to a plurality of types of user equipment; and

a type-specific broadcast information transmitter configured to transmit type-specific broadcast information for each type of the user equipment, in accordance with scheduling information in the common broadcast information.

### Advantageous Effect of the Present Invention

According to the disclosed technology, broadcast information may be efficiently transmitted to various types of user equipment.

### BRIEF DESCRIPTION OF THE DRAWINGS

FIG. 1 is a schematic diagram illustrating a radio communication system according to an embodiment of the present invention;

FIG. 2 is a diagram illustrating an example of mapping of SIB1 according to an embodiment of the present invention;

FIG. 3 is a block diagram illustrating a functional configuration of a base station according to an embodiment of the present invention;

FIG. 4 is a block diagram illustrating a functional configuration of user equipment according to an embodiment of the present invention;

FIG. 5 is a schematic diagram illustrating a relationship between bandwidth capability and SIB1 according to an embodiment of the present invention;

FIG. 6 is a flowchart illustrating a broadcast information receiving process by user equipment according to an embodiment of the present invention;

FIG. 7 is a diagram illustrating a data structure of an MIB according to an embodiment of the present invention;

FIG. 8 is a table defining a relationship between a UE category and SIB1 scheduling information according to an embodiment of the present invention; and

FIG. 9 is a diagram illustrating a hardware configuration of a base station and user equipment according to an embodiment of the present invention.

### EMBODIMENTS FOR CARRYING OUT THE INVENTION

The following describes embodiments of the present invention with reference to the accompanying drawings.

In the following embodiments, a base station and user equipment each configured to transmit and receive broadcast information corresponding to various types of user equipment are disclosed. According to a later-described embodiment, a base station transmits, in a cell, common broadcast information (e.g., a synchronization signal, a reference signal, a master information block (MIB), etc.) commonly transmitted to user equipment of different types (e.g., UE category), and type-specific broadcast information (e.g., a system information block (SIB1), etc.) set for each type of user equipment, in accordance with scheduling information (e.g., scheduling information for a system information block 1 (SIB1), etc.) indicated in the common broadcast information. In the cell, the user equipment receives type-specific broadcast information corresponding to a type of the user equipment, in accordance with scheduling information corresponding to the type of the user equipment in the received common broadcast information.

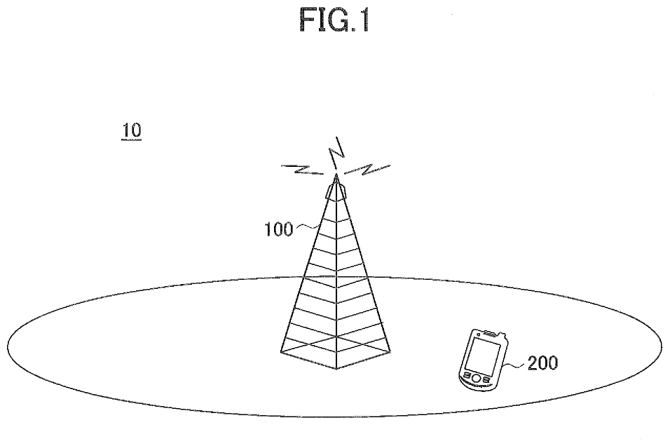

First, a radio communication system according to an embodiment of the present invention will be described with reference to FIG. 1. FIG. 1 is a schematic diagram illustrating a radio communication system according to an embodiment of the present invention.

As illustrated in FIG. 1, a radio communication system 10 includes a base station 100 and user equipment 200. In the following embodiments, the radio communication system 10 is a radio communication system (e.g., 5G or NR system) in compliance with 3GPP Rel-14 or later standards; however, the radio communication system in the present invention is not limited to this example, and any other radio communication system in which broadcast information corresponding to various types of user equipment is transmitted and received may be used. Broadcast information according to the present embodiment includes a synchronization signal (PSS, SSS, etc.), a reference signal (CRS etc.), system information (MIB, SIBx, etc.), and the like; however, broadcast information in the present invention is not limited to this example; broadcast information may contain any other appropriate signals and/or information.

The base station 100 provides one or more cells and wirelessly communicates with user equipment 200. In FIG. 1, only one base station 100 is illustrated; however, in general, a large number of base stations 100 are disposed so as to cover a service area of the radio communication system 10.

The user equipment 200 is any one of suitable information processing apparatuses having a radio communication function, such as a smartphone, a mobile phone, a tablet, a wearable terminal, a M2M (Machine-to-Machine) communication module, and the like. The user equipment 200 wirelessly connects to the base station 100 to use various communication services provided by the radio communication system 10.

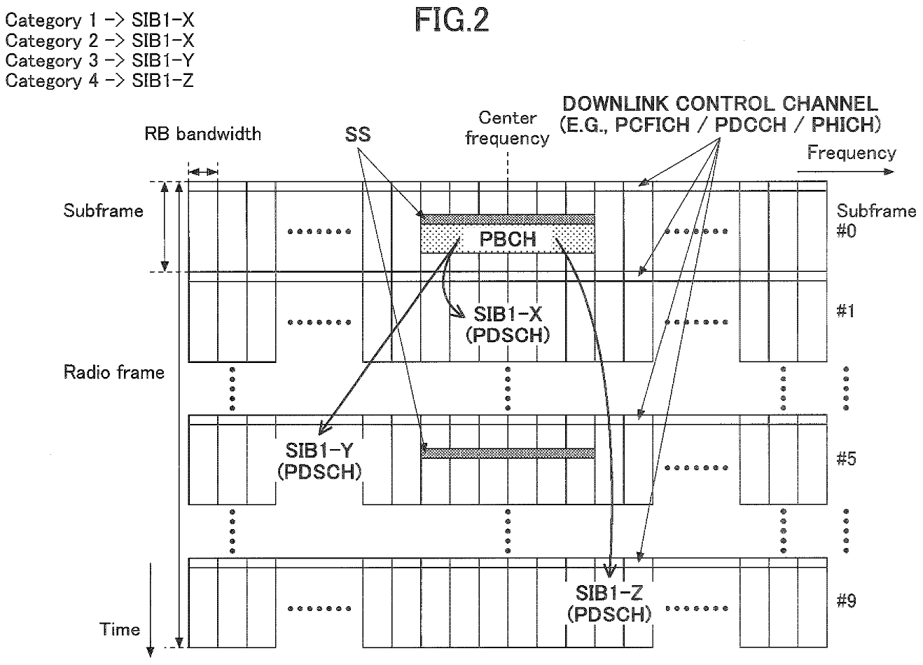

In the present embodiment, various types of user equipment 200 are located or connected to the base station 100. More specifically, user equipment 200 are expected to belong to different categories such as category 1, category 2, . . . (LTE standards up to Rel-12, category M1 and NB-IoT in Rel-13, etc.). The base station 100 makes broadcast information available in common to user equipment 200 for various categories as common broadcast information, and transmits the common broadcast information. Note that the common broadcast information such as a synchronization signal, a reference signal, and MIB is transmitted by fixed radio resources (with respect to the frequency axis direction and the time axis direction). The base station 100 sets SIBx (SIB1, SIB2, . . . ) for each category, and transmits SIB1 for each category on a type-specific basis as type-specific broadcast information according to SIB1 scheduling information indicated in MIB, as illustrated in FIG. 2. That is, the base station 100 transmits MIB including SIB1 scheduling information indicating a transmission schedule of SIB1 (SIB1-X, SIB1-Y, SIB1-Z, etc.) of each category as common broadcast information in the central resource blocks (RBs), and the user equipment 200 receives an SIB1 according to the SIB1 scheduling information corresponding to the type of user equipment 200 in the received MIB. As illustrated in FIG. 2, the common broadcast information including a synchronization signal, a reference signal, and an MIB is transmitted by PBCH (Physical Broadcast Channel), and the type-specific broadcast information including SIB1 is transmitted by PDSCH (Physical Downlink Shared Channel). Note that SIBx as from SIB2 onward is typically transmitted for each category on a type-specific basis according to the SIBx scheduling information in SIB1.

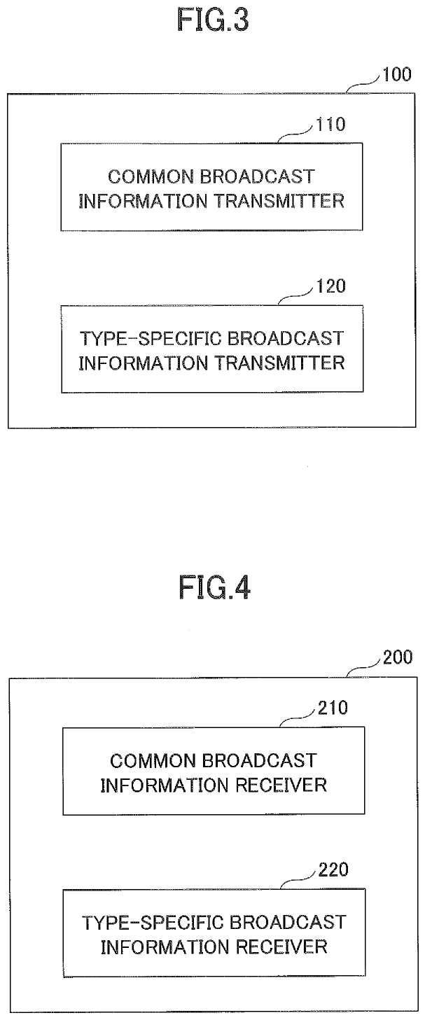

Next, a base station according to an embodiment of the present invention will be described with reference to FIG. 3. FIG. 3 is a block diagram illustrating a functional configuration of a base station according to an embodiment of the present invention.

As illustrated in FIG. 3, the base station 100 includes a common broadcast information transmitter 110 and a type-specific broadcast information transmitter 120.

The common broadcast information transmitter 110 transmits common broadcast information to be transmitted in common to a plurality of types of user equipment 200. For example, the common broadcast information transmitter 110 may transmit common broadcast information in radio resources (e.g., 6 RBs in the center of subframe #0 of each radio resource) that are fixed with respect to a frequency axis direction and a time axis direction. Further, the common broadcast information may include a synchronization signal, a reference signal, and a master information block (MIB), and may be transmitted in the PBCH.

In addition, the common broadcast information includes scheduling information indicating a transmission schedule of type-specific broadcast information for each type of the user equipment 200. The scheduling information is, for example, indicated in MIB. That is, MIB may include SIB1 scheduling information indicating a transmission schedule of SIB1 that is transmitted on a type-specific basis to each type of user equipment 200. Specifically, MIB may include category 1 SIB1 scheduling information indicating a transmission schedule of SIB1 for category 1 user equipment 200, category 2 SIB1 scheduling information indicating a transmission schedule for SIB1 for category 2 user equipment 200, and the like. Category N user equipment 200 receives a category N SIB1 (SIB1-N), in accordance with category N SIB1 scheduling information indicated in the received MIB. Note that N is a numeral or identification symbol indicating types of user equipment corresponding to all the bandwidths in the LTE standards, of user equipment corresponding to category M1 and NB-IoT, and of user equipment defined in the 5G or NR system.

The type-specific broadcast information transmitter 120 transmits type-specific broadcast information for each type of the user equipment 200 according to scheduling information in the common broadcast information. The type-specific broadcast information may, for example, include a system information block 1 (SIB1). Specifically, the type-specific broadcast information transmitter 120 may transmit category N SIB1 (SIB1-N) according to the category N SIB1 scheduling information, and may also transmit SIBx as from SIB2 onward indicated in SIB1-N according to category N SIBx scheduling information for SIBx (SIBx-N). For example, the type-specific broadcast information transmitter 120 may transmit the SIB1-N by PDSCH.

In one embodiment, the scheduling information may include default scheduling information. That is, default SIB1 scheduling information may be defined in a fixed manner in the specifications with respect to the user equipment 200 for a specific category. For example, as with the LTE categories up to Rel-12, the type-specific broadcast information transmitter 120 may transmit SIB1 for the user equipment 200 for the specific category by the PDCCH (Physical Downlink Control Channel) at a fixed interval (e.g., repeating every 20 ms with a periodicity of 80 ms). In this case, the default SIB1 scheduling information may not be indicated in the MIB. For example, when SIB1 scheduling information for category N user equipment 200 is defined in the specifications as default SIB1 scheduling information, the user equipment 200 receives category N SIB1 according to the default SIB1 scheduling information, regardless of the SIB1 scheduling information included in the MIB. According to the present embodiment, the compatibility with the operation of the user equipment for categories corresponding to the LTE standards up to Rel-12 is particularly high. Accordingly, it may be possible to facilitate the design and development of the user equipment for these categories also in the 5G or NR system. Furthermore, it is possible to reduce radio resources for excessive broadcast information while coexisting with user equipment for other categories (user equipment for category M1, and NB-IoT, etc.).

Next, user equipment according to an embodiment of the present invention will be described with reference to FIG. 4. FIG. 4 is a block diagram illustrating a functional configuration of user equipment according to an embodiment of the present invention.

As illustrated in FIG. 4, the user equipment 200 includes a common broadcast information receiver 210 and a type-specific broadcast information receiver 220.

The common broadcast information receiver 210 receives common broadcast information to be transmitted in common to a plurality of types of user equipment 200. For example, the common broadcast information receiver 210 may receive common broadcast information in radio resources (e.g., 6 RBs in the center of subframe #0 of each radio resource) that are fixed with respect to a frequency axis direction and a time axis direction. Further, the common broadcast information may include a synchronization signal, a reference signal, and a master information block (MIB), and may be received in the PBCH.

In addition, the common broadcast information includes scheduling information indicating a transmission schedule of type-specific broadcast information for each type of the user equipment 200. The scheduling information is, for example, indicated in MIB. That is, MIB may include SIB1 scheduling information indicating a transmission schedule of SIB1 that is transmitted on a type-specific basis to each type of user equipment 200. Specifically, the MIB may include category 1 SIB1 scheduling information indicating a transmission schedule of SIB1 for the category 1 user equipment 200, category 2 SIB1 scheduling information indicating a transmission schedule of SIB1 for the category 2 user equipment 200, and the like. The base station 200 transmits SIB1 for each category according to SIB1 scheduling information for a corresponding category indicated in the MIB.

The type-specific broadcast information receiver 220 receives type-specific broadcast information for each type of user equipment 200 according to scheduling information in the common broadcast information. The type-specific broadcast information may, for example, include a system information block 1 (SIB1). Specifically, when user equipment 200 belongs to a category N, the type-specific broadcast information receiver 220 may receive category N SIB1 (SIB1-N) according to the category N SIB1 scheduling information, and may receive SIBx as from SIB2 onward indicated in SIB1-N, according to category N SIBx scheduling information for SIBx (SIBx-N). For example, the type-specific broadcast information receiver 220 may receive SIB1-N by the PDSCH.

In one embodiment, the scheduling information may include default scheduling information. That is, default SIB1 scheduling information may be defined in a fixed manner with respect to the user equipment 200 for a specific category in the specifications. For example, when SIB1 scheduling information for category N user equipment 200 is defined as default SIB1 scheduling information in the specifications, the type-specific broadcast information receiver 220 of the user equipment 200 receives category N SIB1 according to the default SIB1 scheduling information, regardless of the SIB1 scheduling information included in the MIB.

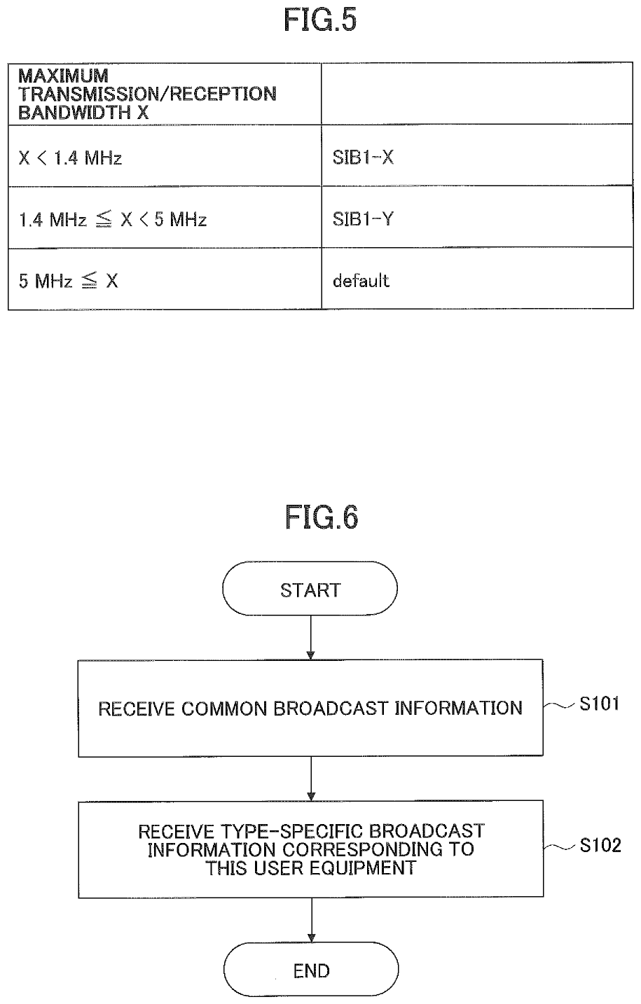

In the above-described embodiment, the SIB1 scheduling information is set for each category of the user equipment 200; however, the present invention is not limited to this example. The SIB1 scheduling information may be set for each bandwidth capability of the user equipment 200, for example. For example, as illustrated in FIG. 5, the SIB1 scheduling information may be set according to whichever predetermined bandwidth ranges the maximum transmission/reception bandwidth X of the user equipment 200 belongs. As illustrated in FIG. 5, when the maximum transmission/reception bandwidth X of the user equipment 200 is less than 1.4 MHz, SIB for the user equipment 200 is SIB-X. The type-specific broadcast information receiver 220 thus specifies the SIB1 scheduling information for the user equipment 200 whose maximum transmission/reception bandwidth X is less than 1.4 MHz in the received MIB, and receives SIB1-X for the user equipment 200 according to the specified SIB1 scheduling information. Further, when the maximum transmission/reception bandwidth X of the user equipment 200 is 1.4 MHz or more and less than 5 MHz, the SIB for the user equipment 200 is SIB-Y. The type-specific broadcast information receiver 220 thus specifies the SIB1 scheduling information for the user equipment 200 whose maximum transmission/reception bandwidth X is 1.4 MHz or more and less than 5 MHz in the received MIB, and receives SIB1-Y for the user equipment 200 according to the specified SIB1 scheduling information. In addition, when the maximum transmission/reception bandwidth X of the user equipment 200 is 5 MHz or more, SIB for the user equipment 200 is default. The type-specific broadcast information receiver 220 receives default SIB1 for the user equipment 200 according to the default SIB1 scheduling information. That is, according to this embodiment, SIB1 scheduling information may be set based on the maximum transmission/reception bandwidth of user equipment 200 regardless of a category of the user equipment 200. Thus, it is possible to flexibly create and/or subdivide a category of the user equipment 200 without introducing new signaling.

Next, a broadcast information receiving process by the user equipment 200 according to an embodiment of the present invention will be described with reference to FIG. 6. FIG. 6 is a flowchart illustrating a broadcast information receiving process by user equipment according to an embodiment of the present invention. For example, the broadcast information receiving process is started when the user equipment 200 is located in or connects to a cell provided by the base station 100.

As illustrated in FIG. 6, in step S101, the common broadcast information receiver 210 receives common broadcast information. For example, the common broadcast information may be transmitted in radio resources, which are fixed with respect to a frequency axis direction and a time axis direction in accordance with the specifications, and may include a synchronization signal, a reference signal, and a master information block (MIB).

In step S102, the type-specific broadcast information receiver 220 receives type-specific broadcast information corresponding to the user equipment 200. That is, the type-specific broadcast information receiver 220 receives type-specific broadcast information corresponding to a category or bandwidth capability of the user equipment 200, in accordance with scheduling information of the type-specific broadcast information in the common broadcast information. Specifically, the type-specific broadcast information receiver 220 receives SIB1 corresponding to the category or bandwidth capability of the user equipment 200, in accordance with SIB1 scheduling information corresponding to the category or bandwidth capability of the user equipment 200 indicated in the MIB received in step S101. Furthermore, the type-specific broadcast information receiver 220 receives SIBx corresponding to the category or bandwidth capability of the user equipment 200, in accordance with SIBx scheduling information of SIBx as from SIB2 onward indicated in the received SIB1.

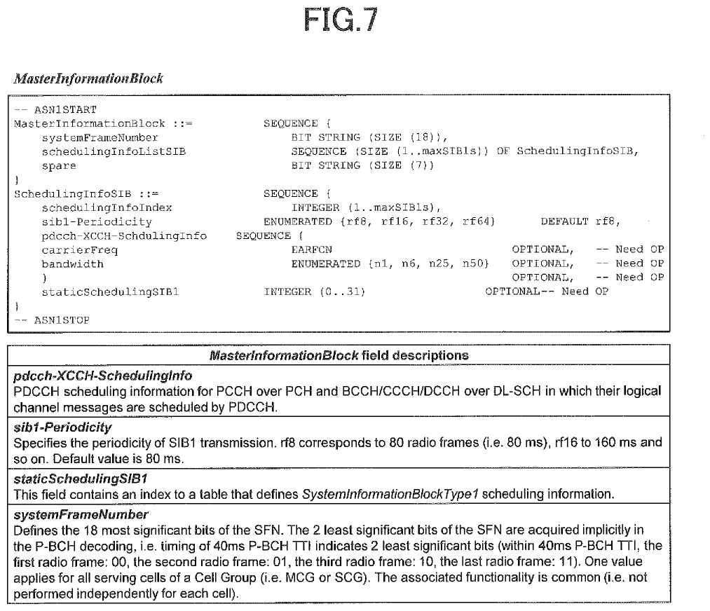

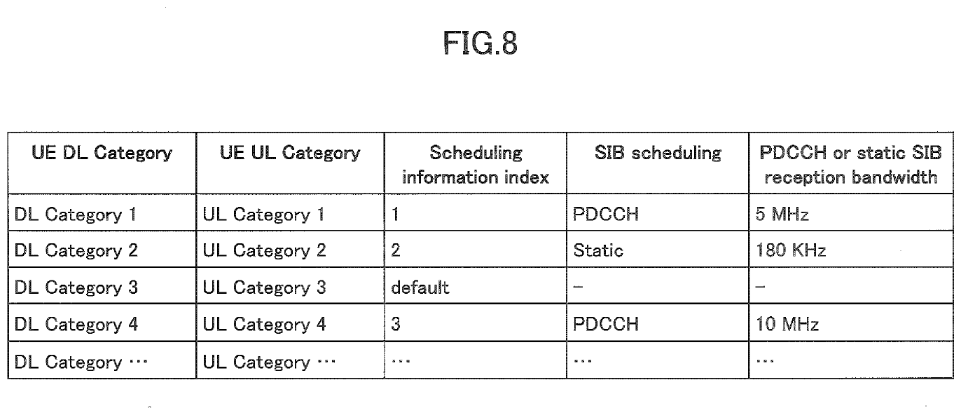

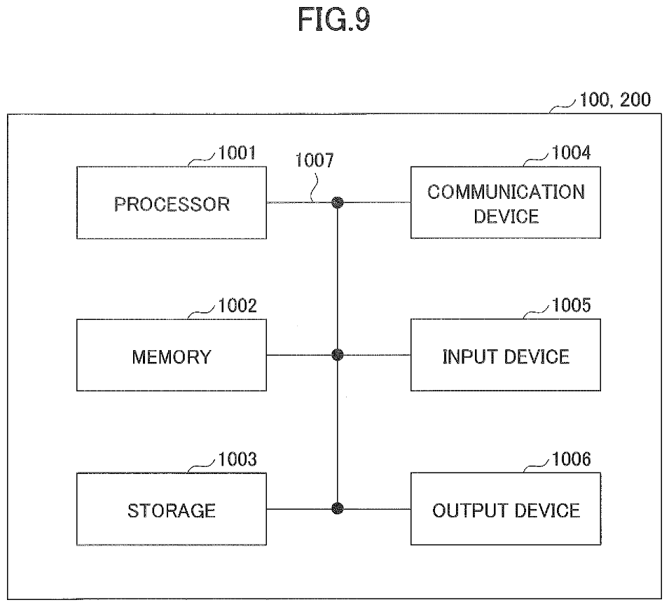

Next, description examples of MIB and SIB1 scheduling information according to an embodiment of the present invention will be described with reference to FIGS. 7 and 8. FIG. 7 is a diagram illustrating a data structure of an MIB according to an embodiment of the present invention.

In the data structure illustrated in FIG. 7, MIB indicates SIB1 scheduling information of each type of user equipment 200 in “SchedulingInfoSIB”. More specifically, in “schedulingInfoIndex”, a type of the user equipment 200 corresponding to the SIB1 scheduling information is indexed. In the example illustrated in FIG. 7, “maxSIB1s” types may be set, and the user equipment 200 refers to “SchedulingInfoSIB” corresponding to the type of the user equipment 200. As illustrated in FIG. 8, categories of the user equipment 200 and indices of the SIB1 scheduling information may be linked in advance. In the example illustrated in FIG. 8, an index 1 is allocated to Category 1, an index 2 is allocated to Category 2, a default is allocated to Category 3, and an index 3 is allocated to Category 4. In addition, a scheduling method of SIB1 (scheduling allocation by PDCCH or semi-static allocation) and reception bandwidth are defined for each category.

In “SchedulingInfoSIB”, “sib1-Periodicity” indicates a transmission periodicity of SIB1. Further, “pdcch-XCCH-SchedulingInfo” indicates whether to schedule SIBx (x=1, 2, . . . ) by PDCCH or statically allocate radio resources without using PDCCH. Moreover, “carrierFreq” and “bandwidth” indicate the center frequency and the reception bandwidth for receiving the PDCCH, respectively, for scheduling by the PDCCH. That is, the designated center frequency and reception bandwidth may be regarded as the center frequency and the reception bandwidth of the PDCCH that are used to schedule SIBx and downlink common messages such as paging. Further, “staticSchedulingSIB1” indicates radio resources for statically allocating the radio resources. For example, the radio resources may be indexed, and the TBS and the number of repetitions corresponding to each index may be predefined.

The above description examples of the MIB and the SIB1 scheduling information are merely examples, and the MIB and the SIB1 scheduling information in the present invention are not limited to these examples.

The block diagrams used for the descriptions of the above-described embodiments represent blocks on a function-by-function basis. These functional blocks (components) are implemented by any combination of hardware and software. Here, a means for implementing each functional block is not particularly limited. Namely, each functional block may be implemented by one device that is physically or logically combined, or may be implemented by a plurality of devices that is obtained by directly or indirectly (e.g., using a wired line or a wireless link) connecting two or more devices that are physically or logically separated. A functional block may be implemented by combining software with the above-described one device or the above-described plurality of devices.

For example, the base station 100 and the user equipment 200 according to the embodiment of the present invention may function as computers for executing a process of the radio communication method of the present invention. FIG. 9 is a block diagram illustrating a hardware configuration of each of the base station 100 and the user equipment 200 according to an embodiment of the present invention. Each of the above-described base station 100 and user equipment 200 may be physically configured as a computer device including a processor 1001, a memory 1002, a storage 1003, a communication device 1004, an input device 1005, an output device 1006, a bus 1007, etc.

Note that, in the following description, the term “device” can be read as a circuit, an apparatus, a unit, etc. The hardware configuration of each of the base station 100 and the user equipment 200 may be configured to include one or more of the respective devices illustrated, or may be configured not to include a part of the devices.

Each function of the base station 100 and the user equipment 200 is implemented by loading predetermined software (program) on hardware, such as the processor 1001 and the memory 1002, so that the processor 1001 performs computation and controls communication by the communication device 1004, and at least one of reading and writing of data in the memory 1002 and the storage 1003.

The processor 1001, for example, operates an operating system to control the entire computer. The processor 1001 may be configured to include a central processing unit (CPU) having an interface with peripherals, a control device, an operation device, and registers. For example, each of the above-described components may be implemented by the processor 1001.

Additionally, the processor 1001 reads a program (program code), a software module and data from at least one of the storage 1003 and the communication device 1004 to the memory 1002, and executes various processes according to these. As the program, a program is used which causes a computer to execute at least a part of the operations described in the above-described embodiments. For example, a process by each component of each of the base station 100 and the user equipment 200 may be implemented by a control program stored in the memory 1002 and executed by the processor 1001, and another functional block may be similarly implemented. Although it is described that the above-described various processes are executed by a single processor 1001, the above-described various processes may be simultaneously or sequentially executed by two or more processors 1001. The processor 1001 may be implemented with one or more chips. Note that the program may be transmitted from a network via an electric communication line.

The memory 1002 may be a computer-readable recording medium composed of at least one of a ROM (Read Only Memory), an EPROM (Erasable Programmable ROM), an EEPROM (Electrically Erasable Programmable ROM), a RAM (Random Access Memory) and the like. The memory 1002 may be referred to as a register, a cache, a main memory (main storage device), etc. The memory 1002 can store executable programs (program codes), software modules, etc., that can be executed to implement the radio communication method according to the embodiment of the present invention.

The storage 1003 is a computer readable recording medium, and, for example, the storage 1003 may be formed of at least one of an optical disk such as a CD-ROM (Compact Disc ROM), a hard disk drive, a flexible disk, a magneto-optical disk (for example, a compact disk, a digital versatile disk, a Blu-ray (registered trademark) disk), a smart card, a flash memory (for example, a card, a stick, a key drive), a floppy (registered trademark) disk, a magnetic strip, etc. The storage 1003 may be referred to as an auxiliary storage device. The above-described storage medium may be, for example, a database including the memory 1002 and/or the storage 1003, a server, or any other suitable medium.

The communication device 1004 is hardware (transmission/reception device) for performing communication between computers via a wired and/or wireless network, and, for example, the communication device 1004 is also referred to as a network device, a network controller, a network card, a communication module, etc. For example, each of the above-described components may be implemented by the communication device 1004.

The input device 1005 is an input device (e.g., a keyboard, a mouse, a microphone, a switch, a button, a sensor, etc.) for receiving an input from outside. The output device 1006 is an output device (e.g., display, speaker, LED lamp, etc.) that performs output toward outside. Note that the input device 1005 and the output device 1006 may be integrated (for example, a touch panel).

Furthermore, the devices, such as the processor 1001 and the memory 1002, are connected by a bus 1007 for communicating information. The bus 1007 may be formed of a single bus, or the bus 1007 may be formed of buses that are different between devices.

Further, the base station 100 or the user equipment 200 may be configured to include hardware, such as a microprocessor, a digital signal processor (DSP: Digital Signal Processor), an ASIC (Application Specific Integrated Circuit), a PLD (Programmable Logic Device), an FPGA (Field Programmable Gate Array), etc., and a part or all of the functional blocks may be implemented by the hardware. For example, the processor 101 may be implemented with at least one of these hardware components.

Notification of information is not limited the aspect/embodiment described in the present specification and may be performed by other methods. For example, notification of information may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block) and SIB (System Information Block))) and other signals or a combination thereof. Moreover, RRC signaling may be referred to as an RRC message, and for example, the RRC message may be an RRC connection setup (RRC Connection Setup) message, a RRC connection reconfiguration (RRC Connection Reconfiguration) message, or the like, for example.

Each aspect/embodiment described herein may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), and a system that utilize other suitable systems and/or a next generation system expanded based on such a system.

In processing procedures, sequences, flowcharts, etc., of each embodiment/modified example described in the specification, the order may be changed provided that there is no contradiction. For example, for the methods described in the specification the elements of the various steps are presented in an exemplary order and are not limited to a specific order presented.

The specific operations that are described in the specification to be performed by the base station 100 may be performed by their upper nodes in some cases. In a network formed of one or more network nodes including a base station, it is apparent that the various operations performed for communication with the terminal may be performed by the base station and/or a network node other than the base station (e.g., MME or S-GW may be considered, however, not limited to these). In the above description, a case is exemplified in which there is one network node other than the base station; however, there may be a combination of other network nodes (e.g., MME and S-GW).

Information, etc., may be output from a higher layer (or a lower layer) to a lower layer (a higher layer). Input and output may be performed through a plurality of network nodes.

Input and output Information, etc., may be stored in a specific location (for example, a memory) and may be managed by a management table. The input and output information and the like may be overwritten, updated, or rewritten. The output information and the like may be erased. The input information and the like may be transmitted to other apparatuses.

Determination may be made by a value (0 or 1) represented by one bit, may be made by a Boolean value (Boolean: true or false), or may be made by comparison of numerical values (comparison with a predetermined value, for example).

Each aspect/embodiment described in this specification may be used alone, may be used in combination, or may be used while being switched during the execution. Furthermore, notification of predetermined information (e.g., notification of “being X”) is not limited to notification that is made explicitly, and the notification may be made implicitly (e.g., notification of the predetermined information is not performed).

The present invention is described in detail above. It is apparent to a person ordinarily skilled in the art that the present invention is not limited to the embodiments described in the specification. The present invention can be implemented as modifications and alterations without departing from the gist and scope of the present invention that are determined by the descriptions of the claims. Accordingly, the description of the present specification is for the purpose of illustration and does not have any restrictive meaning to the present invention.

The software should be widely interpreted to mean an instruction, an instruction set, a code, a code segment, a program code, a program, a subprogram, a software module, an application, a software application a software package, a routine, a subroutine, an object, an executable file, an execution thread, a procedure, a function, etc., regardless of whether the software is referred to as software, firmware, middleware, microcode, hardware description language or other names

Furthermore, software, instructions, etc., may be transmitted and received via a transmission medium. For example, when the software is transmitted from a website, server, or another remote source using at least one of wired technology (e.g., coaxial cable, fiber optic cable, twisted pair and digital subscriber line (DSL)) and wireless technology (infrared, radio, microwave, etc.), at least one of these wired and wireless technologies is included within the definition of the transmission medium.

Information, signals, etc., described in the present disclosure may be represented using any of various other techniques. For example, data, instructions, commands, information, signals, bits, symbols, chips, and the like mentioned in the entire description may be represented by voltage, current, electromagnetic waves, magnetic field or magnetic particles, optical field or photons, or any combination thereof.

Note that the terms described in this disclosure and the terms necessary for understanding of this specification may be replaced with terms having the same or similar meaning. For example, at least one of a channel and a symbol may be signal (signaling). Furthermore, a signal may be a message. Furthermore, a component carrier (CC) may be referred to as a carrier frequency, a cell, etc.

The terms “system” and “network” as used in this disclosure are used interchangeably.

Furthermore, the information, parameters, etc., described in this specification may be represented by absolute values, may be represented as relative values from predetermined values, or may be represented by any other corresponding information. For example, the radio resource may be indicated by an index.

The names used for the above-described parameters are not for limiting in any point. Furthermore, mathematical expressions, etc., using these parameters may be different from those explicitly disclosed in this specification. Since the various channels (e.g., PUCCH, PDCCH, etc.) and information elements (e.g., TPC etc.) can be identified by suitable names, the various names assigned to these various channels and information elements are not for limiting in any point.

A base station can accommodate one or more (e.g., three) cells (also referred to as sectors). When the base station accommodates a plurality of cells, the entire coverage area of the base station can be divided into a plurality of smaller areas, and each smaller area may also provide communication services by base station subsystem (e.g., indoor small base station RRH: Remote Radio Head). The term “cell” or “sector” refers to a part or all of the coverage area of a base station and/or base station subsystem that provides communication service in this coverage. Furthermore, the terms “base station,” “eNB,” “cell,” and “sector” may be used interchangeably in this specification. The base station may also be referred to as a fixed station a NodeB, eNodeB (eNB), an access point, a femtocell, a small cell, etc.

A mobile station may be referred to, by a person ordinarily skilled in the art, as a subscriber station, a mobile unit, a subscriber unit, a wireless unit, a remote unit, a mobile device, a wireless device a wireless communication device, a remote device, a mobile subscriber stations, an access terminal, a mobile terminal, a wireless terminal, a remote terminal a handset, a user agent, a mobile client, a client, or it may also be called by some other suitable terms.

The terms “determine (determining)” and “decide (determining)” used in this specification may include various types of operations. For example, “determining” and “deciding” may include deeming that a result of calculating, computing, processing, deriving, investigating, looking up (e.g., search in a table, a database, or another data structure), or ascertaining is determined or decided. Furthermore, “determining” and “deciding” may include, for example, deeming that a result of receiving (e.g., reception of information), transmitting (e.g., transmission of information), input output, or accessing (e.g., accessing data in memory) is determined or decided. Furthermore, “determining” and “deciding” may include deeming that a result of resolving, selecting, choosing, establishing, or comparing is determined or decided. Namely, “determining” and “deciding” may include deeming that some operation is determined or decided.

The terms “connected,” “coupled,” or any variation thereof mean any direct or indirect connection or coupling between two or more elements, and may include the presence of one or more intermediate elements between the two elements “connected” or “coupled” to each other. The coupling or connection between the elements may be physical, logical or a combination thereof. Two elements, when used in this specification, can be considered to be mutually “connected” or “coupled” by using one more wires, cables and/or printed electrical connections, and, as some non-limiting and non-inclusive examples, by using electromagnetic energy such as electromagnetic energy with a wavelength in a radio frequency range, a microwave range, and an optical range (both visible and invisible).

The reference signal may be abbreviated as RS (Reference Signal), and may be referred to as a pilot (Pilot) according to applicable standards.

The expression “on the basis of” used in the present specification does not mean “on the basis of only” unless otherwise stated particularly. In other words, the expression “on the basis of” means both “on the basis of only” and “on the basis of at least”.

Any reference to elements using names, such as “first” and “second,” as used in this specification does not generally limit the amount or order of those elements. These names can be used in this specification as a convenient way to distinguish between two or more elements. Accordingly, the reference to the first and second elements does not imply that only two elements can be adopted, or that the first element must precede the second element in some way.

“Means” in the configuration of each of the above-described devices may be replaced with “part,” “circuit,” “device,” etc.

As long as “include,” “including,” and variations thereof are used in this specification or the claims, the terms are intended to be inclusive in a manner similar to the term “comprising.” Furthermore, the term “or” used in the specification or claims is intended not to be an exclusive OR.

A radio frame may be formed of one or more frames in the time domain. In the time domain, each of the one or more of frames may be referred to as a subframe. A subframe may be formed of one or more slots in the time domain. A slot may be formed of one or more symbols (OFDM symbols, SC-FDMA symbols, etc.) in the time domain. Each of the radio frame, subframe, slot, and symbol represents a time unit for transmitting a signal. The radio frame, subframe, slot, and symbol may be called by respective different names. For example, in LTE system, the base station performs scheduling to allocate radio resources (a frequency bandwidth, transmission power, etc., that can be used by each mobile station) to each mobile station. The minimum time unit of scheduling may be referred to as TTI (Transmission Time Interval). For example, one subframe may be referred to as TTI, a plurality of consecutive subframes may be referred to as TTI, or one slot may be referred to as TTI. A resource block (RB) is a resource allocation unit in the time domain and the frequency domain, and may include one or more consecutive subcarriers in the frequency domain. Additionally, the resource block may include one or more symbols in the time domain, and may have a length of one slot, one subframe, or one TTI. Each of one TTI and one subframe may be formed of one or more resource blocks. The above-described configuration of the radio frame is merely an example, and the number of subframes included in the radio frame, the number of slots included in the subframe, the number of symbols and resource blocks included in the slot, and the number of subcarriers included in the resource block can be variously changed.

The embodiments of the invention are described above in detail. However, the invention is not limited to the above-described specific embodiments, and various modifications and changes may be made within a range of the gist of the present invention described in the claims.

This application is based upon and claims priority to Japanese Patent Application No. 2017-001305 filed on Jan. 6, 2017, and the entire content of Japanese Patent Application No. 2017-001305 is incorporated herein by reference.

### DESCRIPTION OF REFERENCE SIGNS

10 radio communication system
100 base station
110 common broadcast information transmitter
120 type-specific broadcast information transmitter
200 user equipment
210 common broadcast information receiver
220 type-specific broadcast information receiver

1. A base station comprising:
a common broadcast information transmitter configured to transmit common broadcast information transmitted in common to a plurality of types of user equipment; and
a type-specific broadcast information transmitter configured to transmit type-specific broadcast information for each type of the user equipment, in accordance with scheduling information in the common broadcast information.

2. The base station according to claim 1,
wherein the common broadcast information includes a synchronization signal, a reference signal, and a master information block (MIB),
the type-specific broadcast information includes a system information block 1 (SIB1), and
the MIB includes SIB1 scheduling information indicating a transmission schedule of the SIB1 to be transmitted on a type-specific basis to each type of the user equipment.

3. The base station according to claim 2,
wherein the type-specific broadcast information transmitter sets the SIB1 scheduling information for each category or bandwidth capability of the user equipment.

4. User equipment comprising:
a common broadcast information receiver configured to receive common broadcast information transmitted in common to a plurality of types of user equipment; and
a type-specific broadcast information receiver configured to receive type-specific broadcast information for each type of the user equipment, in accordance with scheduling information in the common broadcast information.

5. The user equipment according to claim 4, wherein the common. broadcast information includes a synchronization signal, a reference signal, and a master information block (MIB),
the type-specific broadcast information includes a system information block 1 (SIB1), and
the MIB includes SIB1 scheduling information. indicating a transmission schedule of the SIB1 to be transmitted on a type-specific basis to each type of the user equipment.

6. The user equipment according to claim 5,
wherein the type-specific broadcast information receiver receives the SIB1 according to the SIB1 scheduling information corresponding to a category or bandwidth capability of the user equipment.
